(19) United States
(12) Patent Application Publication
(10) Pub. No.: US 2006/0055665 A1
(43) Pub. Date: Mar. 16, 2006

(54) User interface having button delineating control panel

(75) Inventors: Donald A. Brown, Honeoye Falls, NY (US); James B. Smith, Honeoye Falls, NY (US); Hidetoshi Kimura, Yokohama-Shi (JP); Shu Watenabe, Yokohama-Shi (JP)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/940,857

(22) Filed: Sep. 14, 2004

(51) Int. Cl. G09G 5/00

(52) U.S. Cl. 345/156

(57) ABSTRACT

A machine user interface (UI) having a control panel that includes (a) controllable machine operating software; (b) a controllable display screen for displaying results from the controllable machine operating software; (c) a housing for the UI containing the controllable display screen; and (d) a button delineating control panel on the housing for containing a first series of buttons for controlling the controllable machine operating software, and a second series of buttons for controlling the controllable display screen. The button delineating control panel includes a first portion having a first plane for containing the first series of buttons, and a second portion having a second plane for containing the second series of buttons. The second plane intersects the first plane forming a delineating angle with the first plane.

### RELATED APPLICATIONS

This application is a utility version of Applicant's design patent application U.S. Ser. No. ______ [Applicant's Docket No. 20041203Q-US-NP] entitled “CONTROL PANEL FOR A USER INTERFACE OF AN IMAGE PROCESSING OFFICE MACHINE”.

The present disclosure is directed to machine user interfaces (UI's), and more specifically to such a user interface having a control panel forming multiple planes for delineating a first series of panel buttons from at least a second and different series of panel buttons, thereby significantly increasing user efficiency and satisfaction by reducing user confusion and frustration typical of single plane, mixed button control panels.

One example of a conventional reprographic machine is the office copier. Traditionally, the copier, in the office equipment context, refers to a light lens xerographic copier in that paper originals are in fact photographed. The images are focused on an area of a photoreceptor that is subsequently developed with toner. The developed image on the photoreceptor is then transferred to a copy sheet that in turn is used to create a permanent copy of the original.

In recent years, however, there has been made available what is known as digital copiers or printing machines. In the most basic functions, a digital copier or printing machine performs the same functions as a light lens copier, except that includes a programmable controller for controlling its functions, and the original image to be copied is not directly focused on a photoreceptor. Instead, with a digital copier or printer, the original image is received, for example, from a personal computer (PC) work station, or storage media, or is scanned by a device generally known as a raster input scanner (RIS) that is typically in the form of a linear array of small photosensors. The controller further enables a wide range of image manipulation and processing capabilities.

The original image received as such is focused on the photosensors in the RIS. The photosensors convert the various light and dark areas of the original image to a set of digital signals. These digital signals are temporarily retained in a memory and then eventually are further processed, and manipulated/and or used as is, with the aid of a user interface (UI) assembly, to operate the digital printing machine or copier when it is desired to print copies of the original. The digital signals may also be sent directly to the digital printing machine or copier without being stored in a memory. Typically however, each such digital printing machine or copier includes a user interface (UI) having an array of features.

User interfaces (UI's) on such digital printing machines or copiers typically include machine operating software, an LCD or full screen display, and a control panel or panels containing a first series of hard buttons for controlling and interfacing with the machine operating software, and a second series for controlling and interfacing with screen display function. The first series, for example, includes pathway/mode selection buttons for controlling and interfacing with the LCD or full screen display. The second series, for example, includes other core control buttons such as the 10 keypad buttons, a start button, a stop button and an interrupt button. Typically, the LCD or full screen display in addition, particularly of the touch-based type, includes graphics in the form of selectable objects such as, rows, icons, tabs, and file folders for example.

In designing such UI's, it is known for example to provide adjacent the LCD or full screen display area, a control panel that includes both machine operating and screen control buttons identified clearly only from a reading of the machine and UI manuals, and from individual button labeling on the panel. Such conventional UI control panels thus typically provide the first and second series of hard control buttons on a single plane panel such that a relationship of the LCD display screen to one of the series is not clear and obvious. In general, in such conventional UI's, there is no obvious linkage to which series of buttons relate to the LCD display screen and which series of buttons are for data entry. Typically therefore, the hard buttons on such a conventional UI sit on the same plane and rely on product graphics, functional groupings, or leader lines to show relationships.

As is well known, such machines are often in use by infrequent users who have not had access to the manual, and/or who have poor eyesight for reading the button labels. It is often also the case that the actual labeling characters also fade out from repeated rubbing from use, and so become illegible. The net result is user confusion, inefficiency and errors, leading to dissatisfaction with such a machine and with its user interface or UI.

In accordance with the present disclosure, there is provided a machine user interface (UI) having a control panel that includes (a) controllable machine operating software; (b) a controllable display screen for displaying results from the controllable machine operating software; (c) a housing for the UI containing the controllable display screen; and (d) a button delineating control panel on the housing for containing a first series of buttons for controlling the controllable machine operating software, and a second series of buttons for controlling the controllable display screen. The button delineating control panel includes a first portion having a first plane for containing the first series of buttons, and a second portion having a second plane for containing the second series of buttons. The second plane intersects the first plane forming a delineating angle with the first plane.

The following is a brief description of the drawings used to describe the present disclosure, and thus, these drawings are being presented for illustrative purposes only and thus should not limit the scope of the present disclosure, wherein:

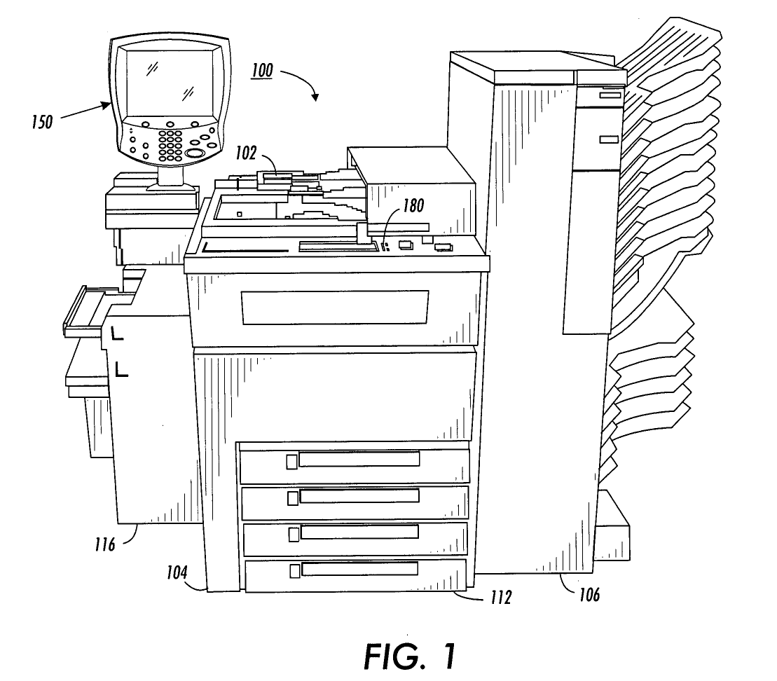

FIG. 1 is an illustration of a reprographic machine including the machine UI button delineating panel in accordance with the present disclosure;

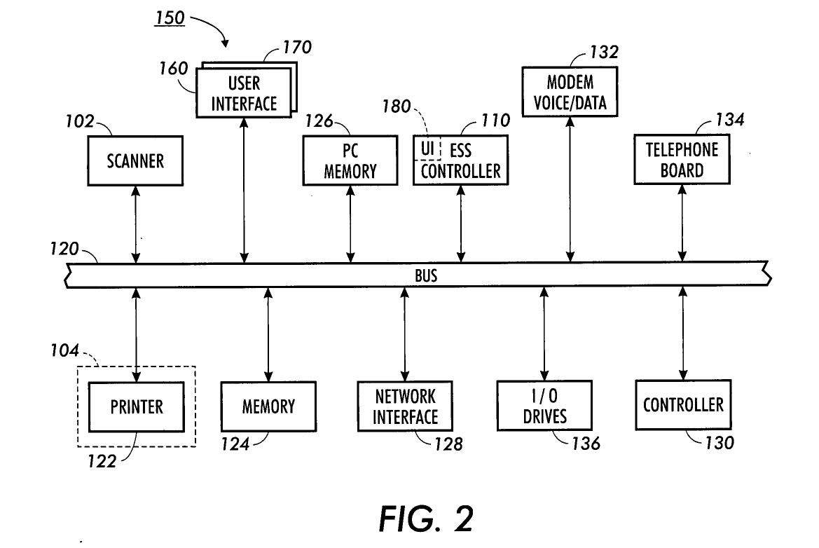

FIG. 2 is a block diagram illustration of the reprographic machine of FIG. 1; and

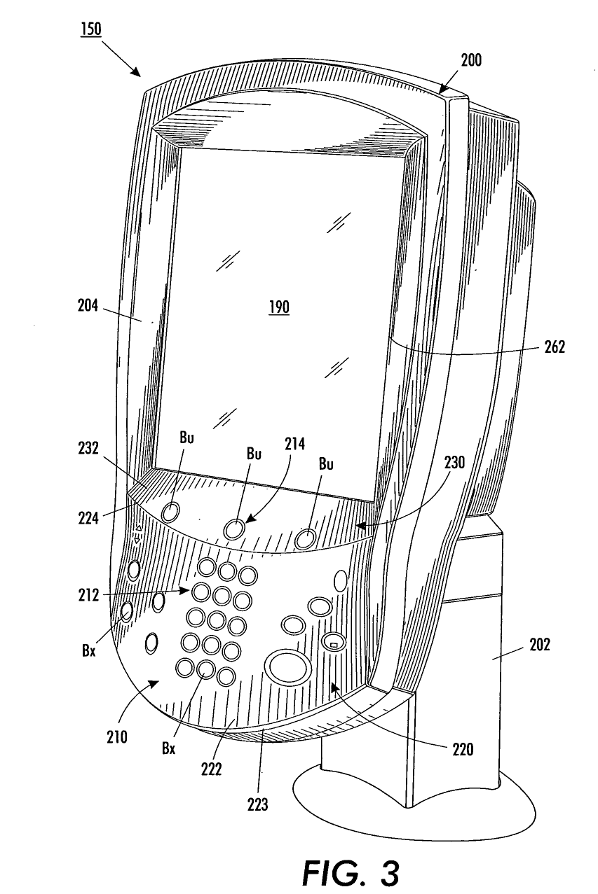

FIG. 3 is perspective view illustration of the machine UI button delineating panel of the present disclosure; and

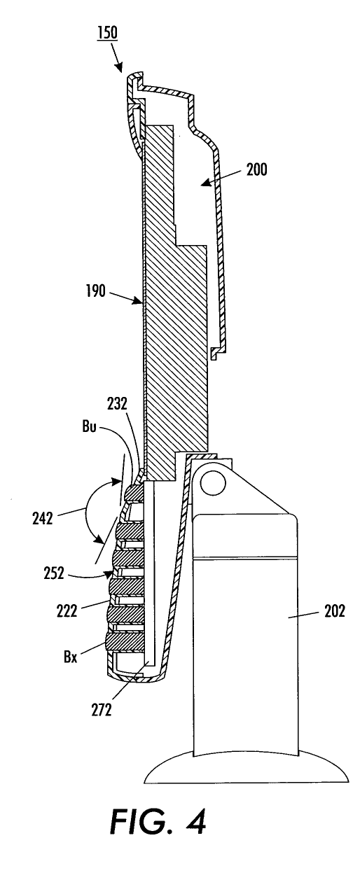

FIG. 4 is a vertical cross-section illustration of the machine UI button-delineating panel of the present disclosure.

### DETAILED DESCRIPTION

The following is a detailed description of the present disclosure. In this description, the drawings have been utilized to illustrate the concepts of the present disclosure. In this description as well as in the drawings, like reference numerals indicate the same items or equivalent items.

Referring now to FIGS. 1-2, an overall construction, and a block diagram, of a digital reprographic machine 100 including the machine UI 150 of the present disclosure, are illustrated. As shown, the digital machine 100 includes a scanning device 102, a printing module 104, and the delineated buttons machine UI 150 of the present disclosure (to be described in detail below). The digital machine 100 may also include a finisher device 106 that may be a sorter, tower mailbox or stapler, and at least an electronic subsystem (ESS) controller 110 for controlling all the features and functions of the machine 100. The printing module 104 may include a plurality of paper trays 112 that store image carrying media such as paper that is used in the printing process. Lastly, the digital machine may include a high capacity feeder 116 that is capable of holding large amounts of media or paper stock to be used by the machine.

In a typical scanning function, the operator would utilize the scanning device 102 to scan in the images from the original documents. This scanning device 102 may be a platen type scanner or may include a constant velocity transport system that moves the original documents across a stationary scanning device. Moreover, the scanning device 102 may also include a document handling system that is capable of placing the original documents, automatically, on the glass platen for scanning.

With respect to the printing functions, the printing module 104 would retrieve the proper paper from one of the multiple paper trays 112 or the high capacity feeder 116, render the desired image on the retrieved paper, and output the printed image to the finishing device 106 for further operations.

An example of the basic architecture of the digital machine 100 is illustrated as a block diagram in detail in FIG. 2, and includes the scanner 102 that converts an original image into a set of digital signals that can be either stored or reproduced. The scanner 102 is connected to a central bus system 120 that may be either a single bus or a plurality of buses that provide interconnections and intercommunications between the various modules and stations on the digital machine.

The digital machine 100 also includes a digital printing device 122 of the printing module 104 (FIG. 2) that converts digital signals representing an image into a hardcopy of that image on a recording medium whether the recording medium be paper, transparency, or other type of markable medium. A first memory device 124 is provided for storing a variety of types of digital information such as machine fault information, machine history information, digital images to be processed at a later time, instruction sets for the machine or job instruction sets. A second memory device forming an electronic pre-collation memory section 126 may be provided for storing the digital representation of the image being presently rendered by the digital printing device 122. In the electronic pre-collation memory 126, the digital image is already laid out in its page structure so that it can be readily rendered by the digital printing device 122.

Since the digital machine 100 may be connected to a network including a PC work station (not shown), it includes a network interface 128 and an additional controller 130 that control the interrelationship between the various modules or stations on the digital machine 100 and the network.

In cases where the digital machine 100 is a multi-function machine, it would include, typically, a voice/data modem 132 and a telephone circuit board 134. Moreover, the digital machine may also include input/output drives 136 such as a floppy disc drive, a CD ROM drive, a tape drive, or other type of drive that can accept a portable memory device.

Referring now to FIGS. 1-7, the digital machine 100, in accordance with the present disclosure, includes (a) devices 102, 104, 106, 110 for forming a toner image on an image carrying medium, and (b) the delineated button machine user interface (UI) 150. The machine user interface (UI) 150 as illustrated includes (a) connections 160, 170 to controllable machine operating software or controller 110, 180; (b) a controllable display screen 190 for displaying results from the controllable machine operating software; (c) a housing 200 for the UI, containing the controllable display screen 190; and (d) a button delineating control panel 210 on the housing for containing a first series 212 of buttons Bx for controlling the controllable machine operating software or controller 110, 180, and a second series 214 of buttons Bu for controlling the controllable display screen 190. The pathway/mode buttons Bu, in the second series 214 include backlighting or an adjacent LED for accentuation when on. The button delineating control panel 210 includes a first portion 220 having a first plane 222 for containing the first series 212 of buttons Bx, and a second portion 230 having a second plane 232 for containing the second series of buttons Bu. The second plane 232 as shown intersects the first plane 222 at a delineating angle 242.

According to other aspect of this disclosure, the second portion 230 and second plane 232 are located between the first portion 220 and the controllable display screen 190. The first plane 222 has a first edge 223, and a second edge 224 that is spaced from the controllable display screen 190, and the second plane 232 intersects the first plane 222 at the second edge 224. The second plane 232 then tilts at the delineating angle 242 from the second edge 224 towards the controllable display screen 190 so that the second series 214 of buttons Bu, as located thereon, appear as on an extension of the controllable display screen 190. As such, the second plane 232 partially surrounds the controllable display screen 190. Further, the first plane 222 and the second plane 232 together form a convex outer surface 252 for the button delineating control panel 210.

Additionally, the controllable display screen 190 can be a touch-based screen. The machine user interface (UI) 150 as a whole includes a mounting support arm 202 for mounting the housing 200 to a machine 100. The housing 200 and the button delineating panel 210 form a two tone facade 204 around the controllable display screen 190 so as to reduce a visual mass of the UI.

Thus in accordance with the present disclosure, in order to make use of the UI 150 less confusing, efficient and not frustrating, the design thereof involves changing the directions of the planes 222, 232 of the outer surface 252 of the control panel 210 so that the outer surface 252 includes a section that tilts or dives towards the LCD display screen 190. Such a section clearly delineates the second series 214 of buttons Bu, for example pathway/mode buttons that typically have a higher usage priority, and that relate to the LCD display screen 190, from the first series 212 of buttons Bx.

This unique approach allows for an intuitive surface “dive” creating a clear and easily understood relationship between the second series 214 or pathway/mode buttons Bu and the LCD display screen 190 by forming a 3D picture frame-like effect around the LCD display screen 190. Such delineation essentially allows the pathway/mode buttons or the second series 214 of buttons Bu to become or appear as an extension of the LCD display screen 190 without taking up “valuable” real estate by having static buttons on the LCD display screen plane 262. Such delineation also enables the use of a relatively smaller UI, thus saving costs without giving up any functionality or usability.

It is important to understand that for a walk-up user or infrequent user, the second series 214 of buttons Bu, or pathway/mode buttons Bu, usually must be pressed first in order to initiate machine operation as well as choose a mode. In accordance with a further aspect of the present disclosure, although the outer surface 252 includes two differently angled planes 222, 232, underneath such surface 252, the UI 150 may utilize a single or same printed circuit board (PCB) 272 for both first and second series 212, 214 of buttons Bx, Bu. This can be accomplished by varying the plastic “key trees” and creating a coplanar key tree button surface.

As pointed out above, the mode buttons of the second series 214 of buttons Bu are either backlit (to showcase current mode) or have an LED next to them to perform the same function as the backlit button. In general, all the hard buttons Bu, Bx also conform to ADA/Section 508 requirements for usage, and give people with low motor skills a depression depth (travel) as well as tactile feedback that LCD touch screens alone do not provide.

As can be seen, there has been provided a machine user interface (UI) having a control panel that includes (a) connections to controllable machine operating software; (b) a controllable display screen for displaying results from the controllable machine operating software; (c) a housing for the UI containing the controllable display screen; and (d) a button delineating control panel on the housing for containing a first series of buttons for controlling the controllable machine operating software, and a second series of buttons for controlling the controllable display screen. The button delineating control panel includes a first portion having a first plane for containing the first series of buttons, and a second portion having a second plane for containing the second series of buttons. The second plane intersects the first plane forming a delineating angle with the first plane.

While the present disclosure has been described with reference to various embodiments as described above, it is not confined to the details set forth above, but is intended to cover such modifications, variations or changes as may come within the scope and spirit of the attached claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A machine user interface (UI) comprising:
(a) connections to controllable machine operating software;
(b) a controllable display screen for displaying results from said controllable machine operating software;
(c) a housing for said UI containing said controllable display screen; and
(d) a button delineating control panel on said housing for containing a first series of buttons for controlling said controllable machine operating software, and a second series of buttons for controlling said controllable display screen, said button delineating control panel including a first portion having a first plane for containing said first series of buttons, and a second portion having a second plane forming a delineating angle with said first plane for containing said second series of buttons.

2. The machine user interface (UI) of claim 1, wherein said second portion is located between said first portion and said controllable display screen.

3. The machine user interface (UI) of claim 1, wherein said first plane has a first edge, and a second edge spaced from said controllable display screen, and said second plane adjoins said second edge and tilts at said delineating angle towards said controllable display screen.

4. The machine user interface (UI) of claim 1, wherein said second plane partially surrounds said controllable display screen.

5. The machine user interface (UI) of claim 11, wherein said first plane and said second plane form a convex outer surface of said button delineating control panel.

6. The machine user interface (UI) of claim 1, wherein said second series of buttons are located so as to appear as an extension of said controllable display screen.

7. The machine user interface (UI) of claim 1, wherein said controllable display screen is a touch-based screen.

8. The machine user interface (UI) of claim 1, including a mounting support arm for mounting said housing to a machine.

9. The machine user interface (UI) of claim 1, wherein said housing and said button delineating panel form a two tone facade around said controllable display screen so as to reduce a visual mass of the UI.

10. The machine user interface (UI) of claim 1, wherein buttons in said series of hard button include backlighting.

11. A digital image printing machine for producing toner images on image carrying media, the electrostatographic reproduction machine comprising:
(a) means for forming a toner image on image carrying media; and
(b) a machine user interface (UI) including:
(i) controllable machine operating software;
(ii) a controllable display screen for displaying results from said controllable machine operating software;
(iii) a housing for said UI containing said controllable display screen; and
(iv) a button delineating control panel on said housing for containing a first series of buttons for controlling said controllable machine operating software, and a second series of buttons for controlling said controllable display screen, said button delineating control panel including a first portion having a first plane for containing said first series of buttons, and a second portion having a second plane forming a delineating angle with said first plane for containing said second series of buttons.

12. The digital image printing machine of claim 11, wherein said second portion is located between said first portion and said controllable display screen.

13. The digital image printing machine of claim 11, wherein said first plane has a first edge, and a second edge spaced from said controllable display screen, and said second plane adjoins said second edge and tilts at said delineating angle towards said controllable display screen.

14. The digital image printing machine of claim 11, wherein said second plane partially surrounds said controllable display screen.

15. The digital image printing machine of claim 11, wherein said first plane and said second plane form a convex outer surface of said button delineating control panel.

16. The digital image printing machine of claim 11, wherein said second series of buttons are located so as to appear as an extension of said controllable display screen.

17. The digital image printing machine of claim 11, wherein said controllable display screen is a touch-based screen.

18. The digital image printing machine of claim 11, including a mounting support arm for mounting said housing to a machine.

19. The digital image printing machine of claim 11, wherein said housing and said button delineating panel form a two tone facade around said controllable display screen so as to reduce a visual mass of the UI.

20. The digital image printing machine of claim 11, wherein buttons in said series of hard button include backlighting.
